(19) United States
(12) Patent Application Publication
(10) Pub. No.: US 2002/0170280 A1
(43) Pub. Date: Nov. 21, 2002

(54) Diesel fuel filters containing smoke suppressant, and a method of slow releasing said suppressant

(76) Inventor: Chin Hin Soh, Petaling Jaya (MY)

Correspondence Address: MARTINE & PENILLA, LLP, 710 LAKEWAY DRIVE, SUITE 170, SUNNYVALE, CA, 94085, US

(21) Appl. No.: 09/904,971

(22) Filed: Jul. 12, 2001

(30) Foreign Application Priority Data
Mar. 23, 2001 (MY) PI 2001 1376

(51) Int. Cl. B01D 46/00

(52) U.S. Cl. 55/524

(57) ABSTRACT

The invention teaches a diesel fuel filter containing a smoke suppressant, and a method of suppressing smoke in exhaust from a diesel engine. The smoke suppressant is adsorbed onto a strip (3) of polyester sponge or mesh. Six to eight strips (3) are inserted in the gaps between the folds of a pleat of filter paper (2), equidistantly around a round container or canister (1), which houses the filter paper (2). The smoke suppressant is slowly released to a stream of diesel fuel flowing through the filter into the diesel engine for subsequent combustion. The additive-coated strips (3) are designed to last the working life of a diesel fuel filter. There are several embodiments of the invention, depending on the sizes or requirements of diesel engines.

### TECHNICAL FIELD

The invention relates generally to diesel fuel filters and smoke suppressant. Particularly, the invention relates to diesel fuel filters containing smoke suppressant, and a method of slow releasing said smoke suppressant.

### PRIOR ART

There is a continuing concern with exhaust smoke from automotive diesel engines. The early 1960s saw a good deal of activity in respect of the development and the application of additives capable of suppressing diesel engine smoke. These additives based originally on barium and calcium, and latterly on manganese, were shown to be able to effect drastic reductions in smoke emission at acceptable treatment costs. However, the additives contain relatively large concentrations of ash-forming materials, and this aspect has been responsible for some difficulty in the field, owing to deposit formation in combustion chambers and also injector nozzles. There is also a general concern expressed about the toxicity of some end products of metal-containing additives. Work is designed to permit injection of smoke suppressants into the exhaust system at both landing and take-off in order to avoid the objectionable plume of smoke emitted close to busy airfields.

According to the Chinese Patent Number CN1055756, a smoke suppressant is an additive made with high potassium iodate, high potassium manganate, dipoly cyclopentadienyl ferrum, polyethylene glycol, glycerine, organic solvent (methanol or alcohol or isopropyl alcohol) and water to composite it by mixing and dissolving according to a certain proportion. The water has obviously the purification and energy saving action inside of engine, convenient for use, simple preparation technology, and low cost. The main disadvantage is that water is introduced to the diesel fuel system, which will affect the engine performance in the long term.

### SUMMARY OF THE INVENTION

The present invention is therefore, as a primary object, to introduce an effective smoke suppressant to a diesel fuel filter, which is part of a fuel combustion system.

Another object of the invention is to slowly release the smoke suppressant throughout the life of the filter in an efficient way.

Yet, another object of the invention is that it should be simple and easy to operate.

The above objects are achieved by teaching a diesel fuel filter containing a smoke suppressant, in the form of a round container or canister and a pleat of filter paper, whereby the smoke suppressant is adsorbed on a strip of sponge or mesh made of non-woven synthetic fibre; and a plurality of said additive-coated strips is equidistantly inserted around the circumference of the round container.

The above objects are also achieved by teaching a method of suppressing smoke in exhaust from a diesel engine comprises the steps of:

incorporating a diesel fuel filter, in the form of a round container or canister and a pleat of filter paper, to a diesel engine being part of a fuel combustion system;

adsorbing a smoke suppressant onto a strip of sponge or mesh made of non-woven synthetic fibre;

inserting, in the gaps between the folds of the pleat of filter paper, a plurality of said additive-coated strips equidistantly around the circumference of the round container; and

releasing said smoke suppressant in the strips to a stream of diesel fuel flowing through the filter into the diesel engine for subsequent combustion.

### BRIEF DESCRIPTION

In order that the present invention may be more readily understood, the following description is given. Reference will be made to the accompanying drawings, in which:

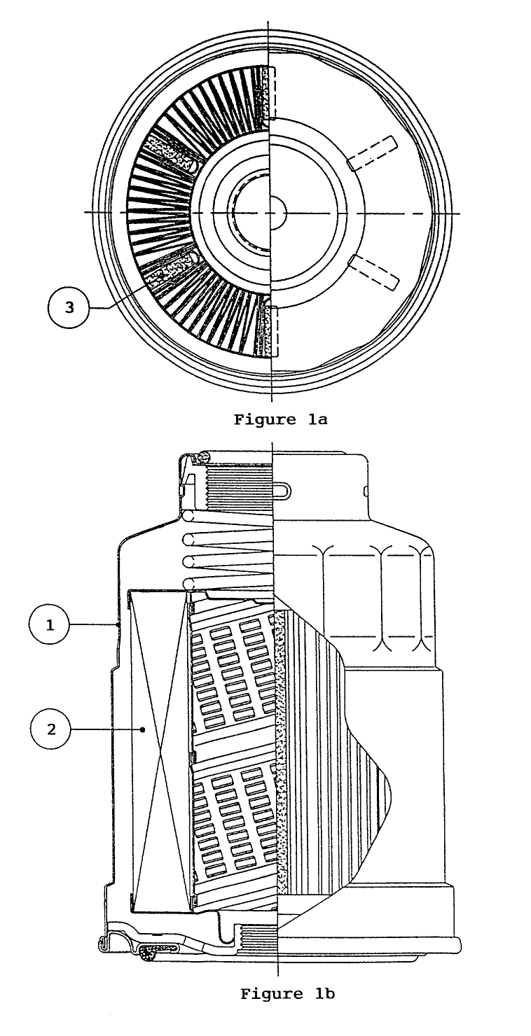

FIG. 1a shows a plan view of the invention in the form of a spin on with nut type canister, where one half shows a cross-sectional view and the other half is the outside view.

FIG. 1b shows a side view of the invention shown in FIG. 1a, where one half shows a cross-sectional view and the other half is the outside view.

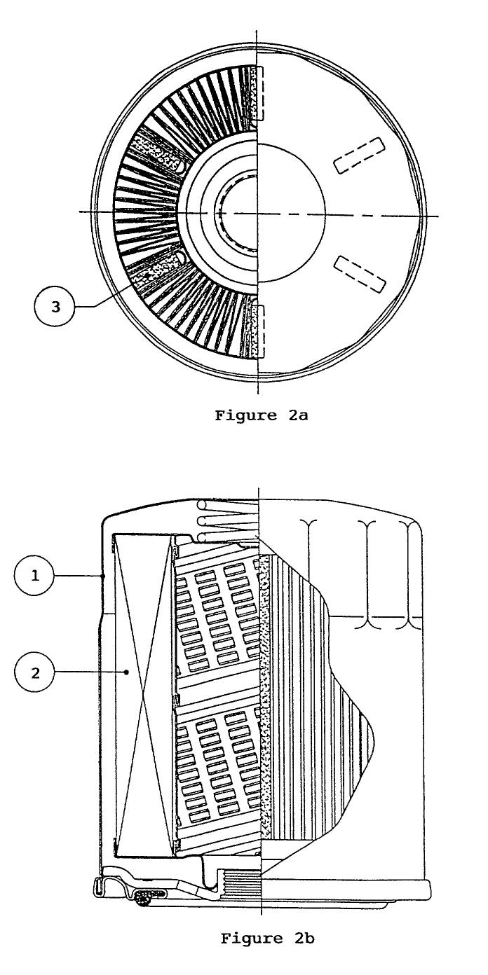

FIG. 2a shows a plan view of the invention in the form of a spin on type canister, where one half shows a cross-sectional view and the other half is the outside view.

FIG. 2b shows a side view of the invention shown in FIG. 2a, where one half shows a cross-sectional view and the other half is the outside view.

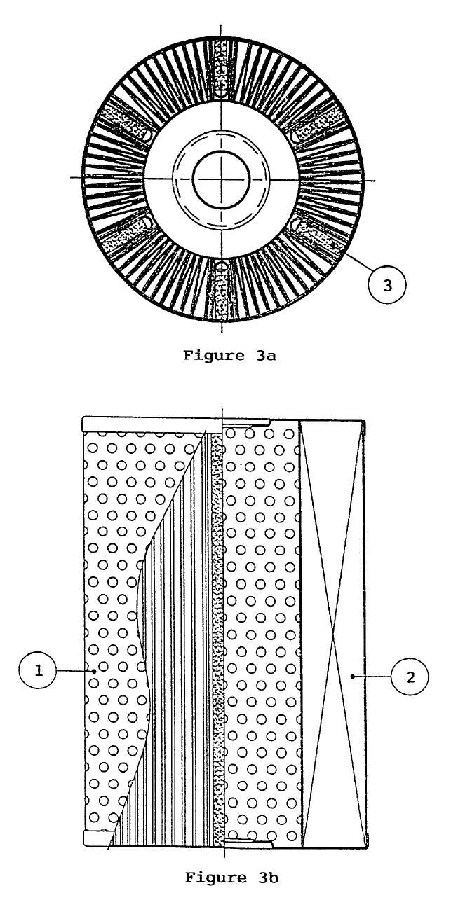

FIG. 3a shows a plan cross-sectional view of the invention in the form of an element type spare part.

FIG. 3b shows a side view of the invention shown in FIG. 3a, partially showing its inner view.

### DETAILED DESCRIPTION

According to the teaching of the invention, a diesel fuel filter containing a smoke suppressant takes the form of a round container or canister (1) and a pleat of filter paper (2), as shown in FIGS. 1a, 1b, 2a and 2b. The smoke suppressant is adsorbed on a sheet of sponge or mesh made of non-woven synthetic fibre, preferably polyester. The sheet can be cut into strips (3) of different sizes according to the field requirements. The sheet is of the size 250 mm×390 mm. The thickness of the strips (3) is 3 mm before treatment and becomes 4.5 mm after treatment. Six to eight additive-coated strips (3) are equidistantly inserted around the circumference of the round container (1).

It is important to note that the smoke suppressant is made of polyethylene glycols (PEG) with minimum 1,800 molecular weight. Alternatively, the smoke suppressant is made from a blend of polyethylene glycols (PEG) with minimum 1,800 molecular weight, and glycols (CH₂OH.CH₂OH) and glycerols (CH₂OH.CHOH.CH₂OH). As with any other fuel, oil requires oxygen in order to burn, and for complete combustion, oil and oxygen in the correct ratio. In theory, 3.5 parts (by weight) of oxygen is required for 1 part of domestic oil fuel. This oxygen is of course obtained from the air. When oil is burned, oxygen in the air combines with carbon to form carbon dioxide and with hydrogen to form water vapour. Most efficient combustion would occur if the oil fuel were brought into intimate contact with oxygen in the approximate proportion of one part oil to between three and four parts oxygen by weight. But, for a variety of reasons, this ideal cannot be achieved in practice. All domestic oil burners are supplied with more air, and therefore more oxygen, than is theoretically necessary for complete combustion of the fuel. In the present invention, the hydroxyl (OH) group of the chemical provides an additional source of oxygen supply.

It is also important to note that the additive-coated strips (3) are designed to last the working life of a diesel fuel filter. In other words, the diesel fuel filter containing smoke suppressant can last for 16,000 km (10,000 miles) before it is replaced.

According to the invention, a method of suppressing smoke in exhaust from a diesel engine comprises the steps of:

incorporating a diesel fuel filter, in the form of a round container or canister (1) and a pleat of filter paper (2), to a diesel engine being part of a fuel combustion system; adsorbing a smoke suppressant onto a strip of sponge or mesh made of non-woven synthetic fibre;

inserting, in the gaps between the folds of the pleat of filter paper (2), a plurality of said additive-coated strips (3) equidistantly around the circumference of the round container (1); and

releasing said chemical in the strips (3) to a stream of diesel fuel flowing through the filter into the diesel engine for subsequent combustion.

Test

A series of tests were conducted to evaluate the effects of the invention on diesel engine's performance in terms of the exhaust emission and engine power. In order to achieve this objective, comparative tests were conducted using a test vehicle. The test vehicle is fitted first with a conventional filter and later with the invention. Engine particulars were: four cylinders in line, SOHC: 2765 c.c. The environmental particulars were: sunny weather, temperature of 30° C., humidity of 68% RH. AVL DiGAS4000 Gas Analyser test procedure and LPS 13 power test procedures were employed.

The test data are tabulated as follows:

| | Conventional | | |
|---|---|---|---|
| Measurement | Filter | Invention | Difference |
| Smoke opacity (%) | 54.0% | 41.5% | −23.1% (decrease) |
| Engine power (kW) | 46 kW | 48 kW | +4.3% (increase) |
| at 3700 rpm | | | |

There are several embodiments of the invention, depending on the requirements and ratings of diesel engines. The diesel fuel filter is usually provided in the form of a spare part element, which is later housed in a container or canister.

As shown in FIGS. 1a and 1b, a spin on with nut type canister (1) containing the additive-coated strips (3) is one embodiment of the invention.

As shown in FIGS. 2a and 2b, a spin on type canister (1) containing the additive-coated strips (3) is another embodiment of the invention. A shown in FIGS. 3a and 3b, an element type spare part containing the additive-coated strips (3) is yet another embodiment of the invention.

1) A diesel fuel filter containing a smoke suppressant, in the form of a round container or canister (1) and a pleat of filter paper (2), is characterised in which
the smoke suppressant is adsorbed on a strip (3) of sponge or mesh made of non-woven synthetic fibre; and
a plurality of said additive-coated strips (3) is equidistantly inserted around the circumference of the round container (1).

2) A diesel fuel filter containing a smoke suppressant as in claim 1 in which the smoke suppressant is made of polyethylene glycols (PEG) with minimum 1,800 molecular weight.

3) A diesel fuel filter containing a smoke suppressant as in claim 1 in which the smoke suppressant is made from a blend of polyethylene glycols (PEG) with minimum 1,800 molecular weight, and glycols (CH₂OH.CH₂OH) and glycerols (CH₂OH.CHOH.CH₂OH).

4) A diesel fuel filter containing a smoke suppressant as in claim 1 in which there are 6 to 8 strips (3) in each round container or canister (1).

5) A diesel fuel filter containing a smoke suppressant as in claim 1 in which the strip (3) of sponge or mesh is made of polyester material.

6) A diesel fuel filter containing a smoke suppressant as in claim 1 in which the additive-coated strips (3) are designed to last the working life of a diesel fuel filter.

7) A method of suppressing smoke in exhaust from a diesel engine comprises the steps of:
incorporating a diesel fuel filter, in the form of a round container or canister (1) and a pleat of filter paper (2), to a diesel engine being part of a fuel combustion system;
adsorbing a smoke suppressant onto a strip (3) of sponge or mesh made of non-woven synthetic fibre;
inserting, in the gaps between the folds of the pleat of filter paper (2), a plurality of said additive-coated strips (3) equidistantly around the circumference of the round container (1); and
releasing said chemical in the strips (3) to a stream of diesel fuel flowing through the filter into the diesel engine for subsequent combustion.
